(19) United States
(12) Patent Application Publication
(10) Pub. No.: US 2004/0219255 A1
(43) Pub. Date: Nov. 4, 2004

(54) Injection molding head

(76) Inventor: Henry C Rust, Evansville, IN (US)

Correspondence Address: Gary K Price, Bowers Harrison, 25 N Riverside Drive, P O Box 1287, Evansville, IN, 47706-1287, US

(21) Appl. No.: 10/486,900

(22) PCT Filed: Jun. 5, 2003
(86) PCT No.: PCT/US03/17943

Related U.S. Application Data
(60) Provisional application No. 60/385,840, filed on Jun. 5, 2002.

(51) Int. Cl. B29C 45/20

(52) U.S. Cl. 425/564; 425/568

(57) ABSTRACT

An injection molding head designed to attach to a prior art extruder designed for extruding relatively large slabs of epoxy based adhesive materials, including materials that may be filled with glass beads or fibers. The injection molding apparatus constructed according to the preferred embodiment of the present invention as described utilizes cooler temperatures and lesser internal pressure during the extruding process than does conventional plastic injection molding machines. The preferred embodiment generally includes an outlet end portion having an outlet end opening, an inlet end portion having an inlet end opening, a center member having an inlet passage with an inlet opening and an outlet passage with an outlet opening, and first and second transfer units. The first and second transfer units are disposed opposite the other with the center member therebetween. The center member including a center bore, an inlet passage in fluid communication with the inlet end portion, and an outlet passage in fluid communication with the outlet end portion. The present invention further includes a rotary valve having a rotary member disposed within the center bore of the center member defining a first partitioned area and a second partitioned area. The rotary member having a first flow channel that directs material to the first transfer unit, and a second flow channel that directs material to the second transfer unit. In the preferred embodiment, the inlet opening having an approximate 4-12 square inch cross section; and the outlet opening having an approximate 0.75 inch cross section; and, the internal pressure of extruding the materials is under 2000 psi.

### CROSS REFERENCES TO RELATED APPLICATIONS

Submission to enter the national state under 35 U.S.C. 371. International application no. PCT/US03/17943, with International filing date of Jun. 5, 2003, and priority date claimed Jun. 5, 2002, with title “Injection Molding Head.”

Statement as to rights to inventions made under federally sponsored research and development: Not Applicable

### BACKGROUND OF THE INVENTION

1. Field of the Invention

This invention relates to an injection molding head, and more particular, an injection molding head designed for attachment to a rubber/mastic extruder capable of accepting relatively large slabs of epoxy based adhesive materials, including materials that may be filled with glass beads and/or fibers.

2. Brief Description of Prior Art

Current plastic injection molding machines are designed to receive resin material, particularly small hard plastic pellets. The pellet material is gravity fed from a hopper and supplied to the center bore of a heat-plasticizing cylinder where the pellets are effectively plasticized and well mixed or kneaded within the heat-plasticizing cylinder. When heated, the pellets form a soft hot mass.

The plasticized material is ejected from the heat-plasticized cylinder by the rotation of a plasticizing screw within the cylinder that oscillates back and forth so that the plasticized material is ejected from the heat-plasticizing cylinder and introduced to the mold cavity of a mold, so as to fill the mold cavity with the resin material, thereby obtaining a desired product of the resin material by injection molding.

The prior art has also proposed the simultaneous use of two conventional, reciprocating screw injection units to allow consistent processing of materials.

This approach allows one or the other of the injection units to be plasticizing material at any point in time, in effect providing continuous plasticizing.

Use of these conventional plastic injection molding machines with an epoxy based adhesive material having semi soft and tacky characteristics, have not been successful. First, the internal pressure of extruding material from these conventional plastic injection molding machines are typically from 5,000 to 10,000 or more psi. Such high molding pressures applied to the subject epoxy based adhesive materials will crush the glass beads therein. Second, the slabs of soft and tacky adhesive materials will not feed like the small hard plastic pellets used in standard injection molding equipment. Third, cycle times are slow as a result of current mold design.

As will be seen from the subsequent description, the preferred embodiments of the present invention overcomes these and other shortcomings of prior art.

### SUMMARY OF THE INVENTION

This present invention relates to an injection molding head, and more particular, an injection molding head designed for attachment to a rubber/mastic extruder capable of accepting large slabs of epoxy based adhesive materials, including materials that may be filled with glass beads and/or fibers. The injection molding head constructed according to the preferred embodiment of the present invention utilizes cooler temperatures and less internal pressure during the extruding and molding process than does conventional plastic injection molding machines. The preferred embodiment generally includes an outlet end portion having an outlet opening and an inlet end portion having an inlet opening, a center member, and lower and upper transfer units. The lower and upper transfer units disposed opposite the other with the center member therebetween. The center member including a center bore, an inlet passage in fluid communication with the inlet end portion, and an outlet passage in fluid communication with the outlet end portion. The present invention further includes a rotary valve having a rotary member disposed within the center bore of the center member defining a first partitioned area and a second partitioned area. The valve member having a first flow channel that directs material to the upper transfer unit, and a second flow channel that directs material to the lower transfer unit. In the preferred embodiment, the inlet opening having an approximate 4-12 square inch cross section, and the outlet opening having an approximate 0.75 inch cross section.

### BRIEF DESCRIPTION OF THE DRAWINGS

FIG. 1 is a perspective view of a preferred embodiment of the present invention, an injection molding head.

FIG. 2 is an exploded perspective view of the injection molding head of FIG. 1.

FIG. 3 is a perspective view of the injection molding head of FIG. 1, where one end of the injection molding head is connected to an extruder, and the opposite end of the injection molding head is connected to a mold.

FIGS. 4 & 5 illustrate alternate embodiments of the injection molding head of the present invention.

### DESCRIPTION OF THE PREFERRED EMBODIMENT

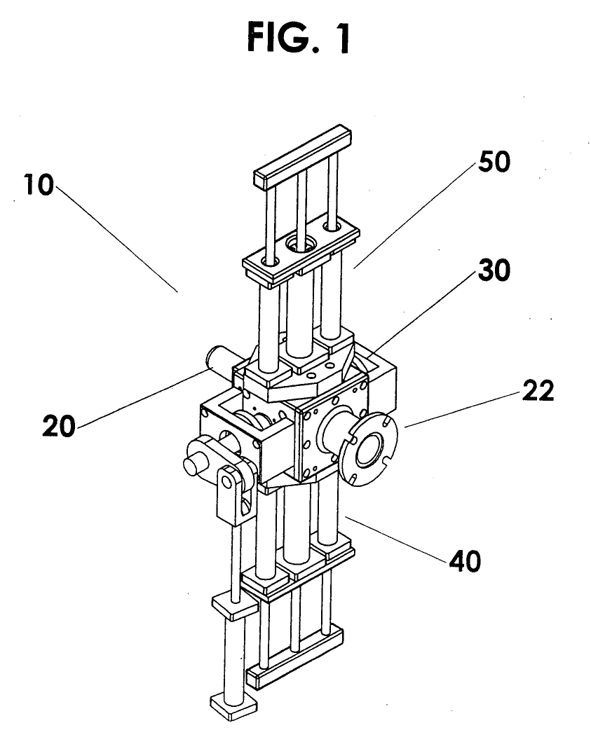

FIGS. 1-3 illustrate a preferred embodiment of an injection molding head 10 made in accordance with the present invention. The injection molding head 10 generally designed to take discharged material (not shown) (herein referred to as the “material”) from a rubber/mastic extruder known in the art for accepting epoxy or other soft tacky material, and injecting the material into a mold cavity. The material being relatively large slabs of epoxy based adhesive materials, including materials that may be filled with glass beads or fiber.

In general, the material is extruded by a prior art extruder 110 similar to one produced by The Bonnot Company. The extruder 110 has a large hopper 111 with a large screw auger (not shown) positioned inside the hopper 111. The hopper 111 and screw auger designed to accept large sticky slabs or chunks of the material. The raw material being generally from ¼ cubic foot to 1 cubic foot in size. The standard extruder 110 further including a heating means (not shown) for merely softening the material, and a discharge end 120 having an output (not shown) that feeds the heated material from the extruder 110 to the injection molding head 10.

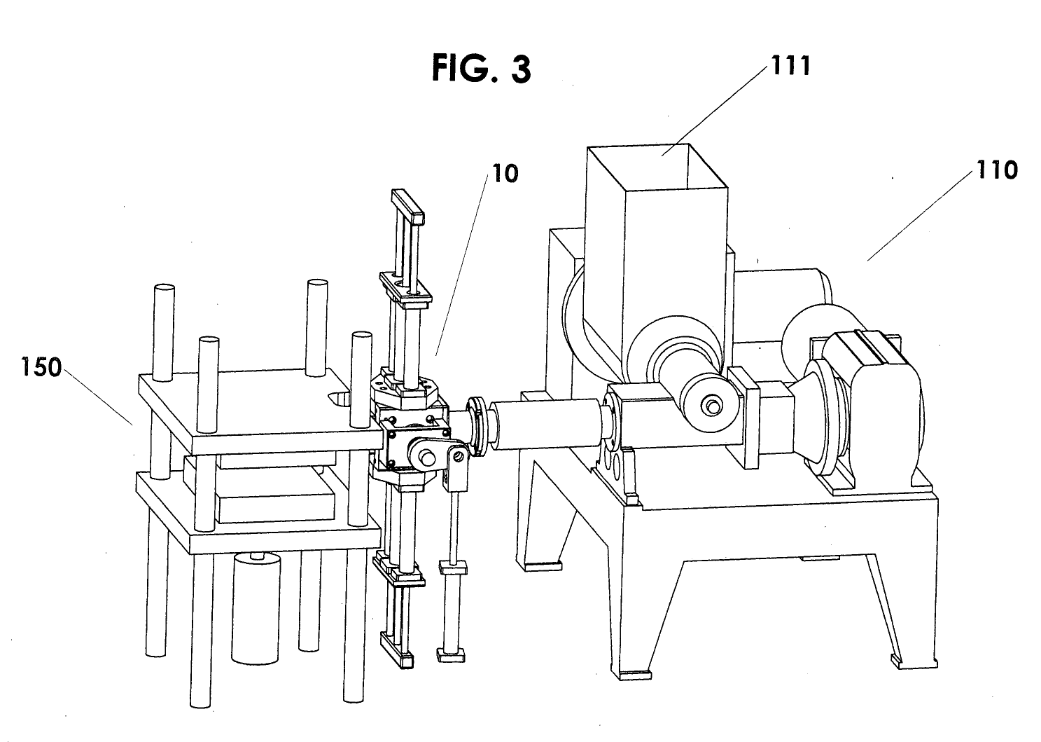

As shown in FIG. 3, the injection molding head 10 is approximately attached to the discharge end 120 of the standard extruder 110. As best shown in FIG. 1, the injection molding head 10 generally includes an outlet end portion 20 and an inlet end portion 22, a center member 30, and a lower and upper transfer units 40, 50. The upper transfer unit 50 and the lower transfer unit 40 are disposed opposite the other with the center member 30 therebetween. As will be further described, the lower and upper transfer units 40, 50 each including a fill chamber, 45, 55, respectively.

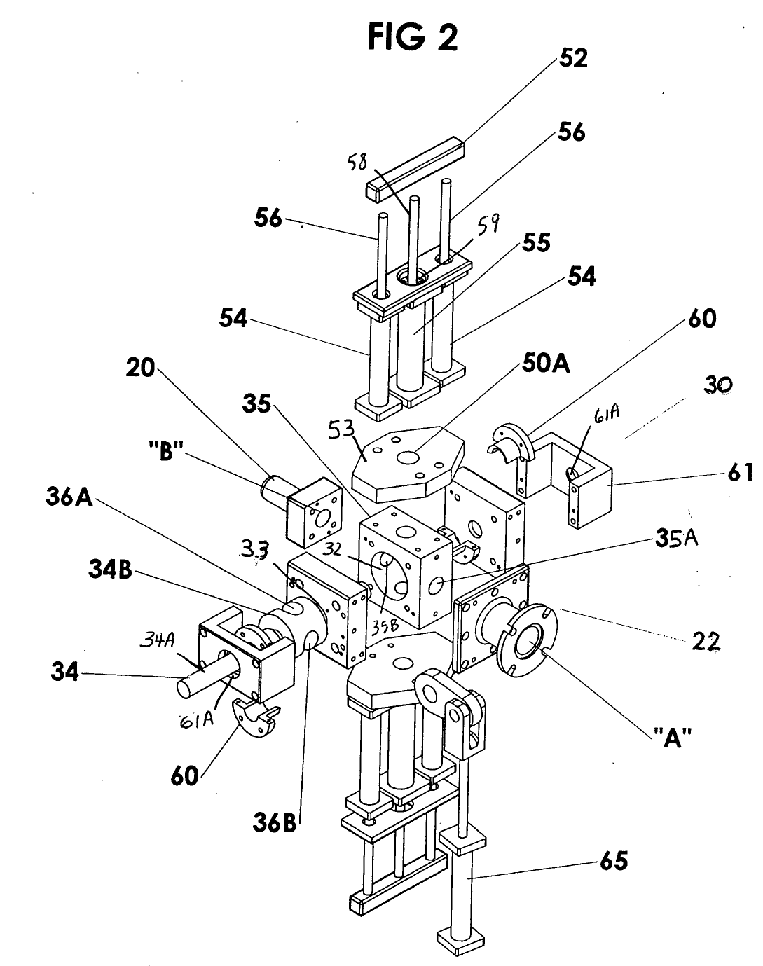

Referring to FIG. 2, the center member 30 includes a center bore 32 and a rotary valve 34. The rotary valve 34 having a shaft portion 34A and a valve member 34B, the valve member 34B rotatably extends within the interior width of the center bore 32 of the center member 30. As will be described, the rotary valve 34 is disposed in relative perpendicular relationship to the lower and upper transfer units 40 and 50. In application, the material is supplied to the center bore 32 of the center member 30, and is then introduced alternatively to either the lower fill chamber 45 or the upper fill chamber 55. The material is then injected through the outlet end portion 20 into a mold cavity of a mold 150 (shown in FIG. 3), so as to fill the mold cavity with the material, thereby obtaining a desired product of the material by injection molding.

The rotary valve 34 and mating components are designed to allow a large flow of the material through the injection molding head 10 under relatively low pressure. The valve member 34B of the rotary valve 34 is rotatably positioned within the center bore 32 of the center member 30, for rotatably directing material between the lower transfer unit 40 and the upper transfer unit 50. On the outer surface of the center member 30 may be bonded a plurality of heating members (not shown) known in the art. The heating members for warming the material received within the center member 30 as described.

The center member 30 further including an inlet passage 35A through which the material is received from the inlet end portion 22, which inlet end portion 22 is appropriately attached to the discharge end 120 of the extruder 110. The center member 30 further including an outlet passage 35B located opposite the inlet passage 35A, the outlet passage 35B through which the material is ejected through the outlet end portion 20 into the mold cavity of the mold 150.

In the preferred embodiment, an opening designated as “A” in FIG. 2, defined in the inlet end portion 22 has an approximate 4-12 square inches of cross section in order to allow a large flow or volume of the material from the outlet of the discharge end 120 of the extruder 110 at a relatively low pressure in order to avoid crushing the glass beads in the material during the injection cycle. This also greatly reduces the friction of the material flowing through the injection head 10. Further, the preferred opening size (referred to as “B” in FIG. 2) of the outlet end portion 20 is about 0.75 inches or approximately 200-400% larger than the prior art and allows to keep the internal pressure of the injection head 10 lower. The discharge end of the prior art extruder such as the one produced by The Bonnot Company and similar extruders, generally has an output diameter in the range of 2″ to 8″ or more. As such, the bore size through the injection head 10 namely, openings “A” and “B”, and passages 35A and 35B may vary depending on the output diameter of the discharge end 120 and the desired volume of material received from the extruder 110 per hour.

The valve member 34B is fixedly supported to rotate within the center member 30 directing the material to either the upper fill chamber 55 or the lower fill chamber 45. In the preferred embodiment, the valve member 34B is driven to rotate by a hydraulic cylinder 65 known in the art, that attaches to the shaft portion 34A of the rotary valve 34.

In application, the valve member 34B is positioned within the center bore 32 of the center member 30. The valve member 34B effectively defines two partitions (not shown) within the center bore 32 of the center member 30, the first partitioned area for receiving material from the fill chambers 45,55 and directing the material to the outlet end portion 20 as will be further described. The second partitioned area for receiving material from the inlet end portion and directing the material to one of the fill chambers 45, 55 as will be further described.

The valve member 34 further defines a first flow channel 36A disposed in the valve member 34B, the first flow channel 36B designed to direct the material to the upper fill chamber 55, and a second flow channel 36B disposed in the valve member 34B, the second flow channel 36B designed to direct the material to the lower fill chamber 45.

The center member 30 further including a pair of end plates 33A and 33B disposed on opposite sides of the center member 30 in communication with the center bore 32. Packing glands 60 are disposed within the end plates 33A, B (shown in the exploded view of FIG. 2), the packing glands 60 effectively create a seal between the rotary valve 34 and the respective end plate 33A, 33B to prevent leakage of the material therefrom. A pair of support members 61 each including an opening 61A sized to receive the shaft portion 34A of the rotary valve 34.

The material is introduced into the center bore 32 of the center member 30 at an axial middle portion of the center member 30, and is transferred alternatively to either the upper fill chamber 55 or the lower fill chamber 45 by selective rotation of the valve member 34B.

The upper transfer unit 50 further includes an upper plate 52, a pair of hydraulic cylinders 54 positioned perpendicular to the upper plate 52, and the upper fill chamber 55 positioned parallel with the hydraulic cylinders 54. The hydraulic cylinders 54 each having a piston rod 56. One end of the piston rod 56 attached to the hydraulic cylinder 54 and the opposite end of the piston rod 56 is attached to the upper plate 52. The piston rod 56 of each of the hydraulic cylinders 54 are driven so that the upper plate 52 can be positioned relative to the center member 30 by the positioning of the hydraulic cylinders 54.

As shown in the drawings, the upper fill chamber 55 further includes a tie rod 58. One end of the tie rod 58 is attached to the approximate center of the upper plate 52, and downwardly extends from the upper plate 52 through a receiving bore 59 of an upper fill chamber 55 and attaches to a prior art piston (not shown) positioned within the upper fill chamber 55. The receiving bore 59 of the chamber 55 is in fluid communication with a material passage 50A of an attachment plate 53, to the center bore 32 of the center member 30. Thus, the upper plate 52 is movable toward and away from the center member 30 in an axial direction of the tie rod 58. The material passage 50A and the receiving bore 59 are in communication with the center bore 32 of the center member 30 for receiving the material from the center member 30 and for injecting the material.

The receiving bore 59 of the upper fill chamber 55 extends through the central portion of the chamber 55 in a vertical direction. The receiving bore 59 has a cylindrical shape and receives one end of the tie rod 58. The tie rod 58 further having a cylindrical shape and sized to be slidably disposed within the receive bore 59. The receiving bore 59 further receives the material when directed to the upper fill chamber 55 of the upper transfer unit 50. On the outer surface of the upper fill chamber 55 may be bonded a plurality of heating members (not shown) known in the art. The heating members for warming the material received in the chamber 55.

As should be appreciated from the description herein, the injection molding head 10 is symmetrically constructed with the lower and upper transfer units 40, 50 on opposite ends of the center member 30. Only the elements found on the upper transfer unit 50 is primarily discussed herein. As shown in the drawings, it should be understood that the elements of the lower transfer unit 40 are identical to those described in the upper transfer unit 50, with the exception that the elements of the lower transfer unit 40 are mirror images of the elements described in the upper transfer unit 50.

The injection molding apparatus constructed in accordance with the preferred embodiment of the present invention as described above can provide a desired product by receiving relatively large slabs of epoxy based adhesive materials, or similar soft and tacky materials, or the like. Initially, the material is extruded in the prior art extruder 110 similar to one produced by The Bonnot Company. The extruder 110 has a large hopper 11 with a large screw auger therein so that the extruder 110 will accept large sticky slabs or chunks of the material. The raw material being generally from ¼ cubic foot to 1 cubic foot in size. The standard extruder 110 further including a heating means for merely softening the material, and the discharge end 120 for ejecting the heated material from the extruder 110. The inventor has found that warming the material to about 115-140 degrees Fahrenheit will soften the material as preferred. The injection molding head 10 is appropriately attached to the discharge end 120 of the standard extruder 110. The material is pressure fed through the discharge end 120 of the standard extruder 110 towards the inlet end portion 22 of the injection molding head 10. The inventor has found that applying under 2000 psi of internal pressure avoids crushing the glass beads in the material during the extruding process. As described, the large openings designated “A” and “B” in the injection head 10 reduces friction and allows the material to more easily flow.

In the lower and upper fill chambers 45 and 55, the hydraulic cylinders 54 of the upper transfer unit 50 and hydraulic cylinders 44 of the lower transfer unit 40 are moved to their advanced positions, while the valve member 34B is rotated within the center bore 32 to the position in which the first flow channel 36A directs the material to the upper transfer unit 50, or positioned so that the second flow channel 36B directs the material to the lower transfer unit 40.

With the valve member 34B placed in one of the above described positions, the material is supplied into the center member 30 and introduced into either the upper fill chamber 55 of the upper transfer unit 50 or the lower fill channel 45 of the lower transfer unit 40. As the material is introduced into the upper fill chamber 55 for example, this step is terminated when it is determined that the chamber 55 has received and stored a pre-determined amount of the material.

Next, the valve member 34B is rotated 180 degrees so that the alternate second flow channel 36B (for example) of the valve member 34B is positioned to direct material to the lower transfer unit 40. In this condition, the injection molding head 10 continues to receive material from the extruder 110. Simultaneous with the lower fill chamber 45 receiving material from the center member 30, the received material stored in the upper fill chamber 55 of the upper transfer unit 50 is injected from the upper fill chamber 55 through the material passage 50A into the center bore 32, and through the outlet end portion 20 into the cavity mold 150. To do so, the piston attached to the tie rod 58 and disposed within the upper fill chamber 55 is advanced by the upper plate 52 towards the center member 30, so that the material within the upper fill chamber 55 is forced and injected from the upper fill chamber 55 of the upper transfer unit 50 through the material passage 50A, into the center bore 32 of the center member 30, through the outlet passage 35B of the center member 30, through the outlet end portion 20 and into the cavity mold 150, in the order of the description.

Repeated operation of a series of the steps as described above assures that the lower and upper units 40 and 50 are alternatively advanced to inject the material into the mold cavity of the mold 150 so that a plurality of pieces are produced while the mold is repeatedly opened and closed.

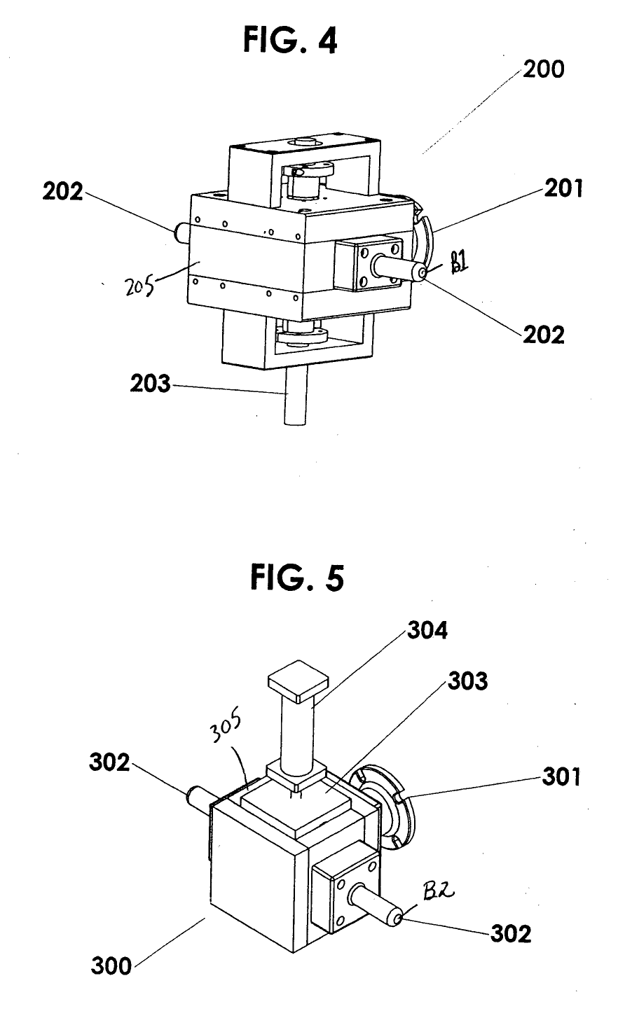

FIG. 4 illustrates an alternate embodiment of an injection head 200 including an inlet adaptor 201 in communication with a main body portion 205. The injection head 200 further includes outlet nozzles 202 disposed on opposite sides of the main body 205, and a rotary valve 203. The rotary valve 203 operationally similar to the rotary valve 34 previously described. The valve member (not shown) of the rotary valve 203 for directing material that is introduced within the main body 205 through the inlet adaptor 201 to one of the outlet nozzles 202.

The application of the injection head 200 is similar to the application of the injection head 10 of the preferred embodiment except that the injection head 200 eliminates the step of directing material from the main body 205 to upper or lower fill chambers. In this embodiment, an opening (not shown) in the inlet adapter has an approximate 4-12 square inches of cross section in order to allow a large flow or volume of the material at a relatively low pressure in order to avoid crushing the glass beads in the material during the injection cycle. This also greatly reduces the friction of the material flowing through the injection head 200. Further, the preferred opening size (referred to as “B1” in FIG. 4) of the outlet nozzles 202 is about 0.75 inches or approximately 200-400 percent larger than the prior art and allows to keep the internal pressure of the injection head 200 lower.

FIG. 5 illustrates a second alternate embodiment of an injection head 300 including a slide valve 303, the slide valve 303 including a pair of channels (not shown) that directs the material received. The injection head 300 further includes an inlet adaptor 301, in communication with a main body portion 305, and outlet nozzles 302 positioned on opposite sides of the main body 305. A hydraulic cylinder 304 is attached to the slide valve 303 to pivot the valve 303 to direct the flow of material.

The application of the injection head 300 is similar to the application of the injection head 10 of the preferred embodiment. In particular, the material is directed from the extruder, through the inlet adaptor 301 and into the main body portion 305. The material within the main body portion 305 is alternately directed to one of the channels within the slide valve 303, the channels then direct the material to the selected outlet nozzles 302. An opening (not shown) defined in the inlet adaptor 301 has an approximate 4-12 square inches of cross section in order to allow a large flow or volume of the material at a relatively low pressure in order to avoid crushing the glass beads in the material during the injection cycle. This also greatly reduces the friction of the material flowing through the injection head 300. Further, the preferred opening size (referred to as “B2” in FIG. 5) of the outlet nozzles 302 is about 0.75 inches or approximately 200-400 percent larger than the prior art and allows to keep the internal pressure of the injection head 300 lower.

Although the description above contains many specificities, these should not be construed as limiting the scope of the invention but as merely providing illustrations of a presently preferred embodiment of this invention.

For example, while the above description and drawings show a hydraulic cylinder 65 attached to the rotary valve 34 to pivot the valve 34 to direct the flow of material. Various other kinds of driving mechanisms known in the art such as an electric motor or a hydraulic motor may be used as driving means for rotating the valve member 34B, as well as rotating the lower and upper plates 42, 52 of the lower and upper fill chambers 45, 55 toward and away from the center member 30.

Thus the scope of the invention should be determined by the appended claims in the formal application and their legal equivalents, rather than by the examples given.

I claim:

1. An injection molding head designed for receiving epoxy based adhesive materials from an extruder, and designed to extrude relatively large slabs of said epoxy based adhesive materials into a mold cavity, said injection molding head comprising:
an inlet end portion having an inlet opening;
an outlet end portion having an outlet opening;
a center member disposed between first and second transfer units, said center member comprising a center bore, an inlet passage in fluid communication with the inlet end portion, and an outlet passage in fluid communication with the outlet end portion;
wherein the inlet opening having an approximate 4-12 square inch cross section;
wherein the outlet opening having an approximate 0.75 square inch cross section.

2. The injection molding head as recited in claim 1, further comprising a rotary valve, said rotary valve comprising a rotary member.

3. The injection molding head as recited in claim 2, wherein the rotary member rotatably extends within the center bore of the center member defining a first partitioned area and a second partitioned area.

4. The injection molding head as recited in claim 1, wherein the outlet end portion and the inlet end portion is on an axis.

5. The injection molding head as recited in claim 3, wherein the rotary member defining a first flow channel that directs the material to the first transfer unit, and a second flow channel that directs the material to the second transfer unit.

6. An injection molding head designed for receiving epoxy based adhesive materials from an extruder, and designed to extrude relatively large slabs of said epoxy based adhesive materials into a mold cavity, said injection molding head comprising:
a main body portion;
an inlet end portion;
first and second outlet end portions disposed on opposite sides of the main body portion;
said main body portion comprising a center bore, an inlet passage in fluid communication with the inlet end portion, a first outlet passage in fluid communication with the first outlet end portion, and a second outlet passage in fluid communication with the second outlet end portion;
a rotary valve that extends within the center bore of the main body portion defining a first partitioned area and a second partitioned area;
wherein the inlet end portion having an opening, said opening having an approximate 4-12 square inch cross section;
wherein the first and second outlet end portions each having an opening, each of said openings having an approximate 0.75 square inch cross section.

7. The injection molding head as recited in claim 6, wherein the rotary valve defining a first flow channel that directs the material to the first outlet end portion, and a second flow channel that directs the material to the second outlet end portion.

8. An injection molding head designed for receiving epoxy based adhesive materials from an extruder, and designed to extrude relatively large slabs of said epoxy based adhesive materials into a mold cavity, said injection molding head comprising:
a main body portion;
an inlet end portion;
first and second outlet end portions disposed on opposite sides of the main body portion;
said main body portion comprising a center bore, an inlet passage in fluid communication with the inlet end portion, a first outlet passage in fluid communication with the first outlet end portion, and a second outlet passage in fluid communication with the second outlet end portion;
a slide valve comprising a first channel in fluid communication with the first outlet passage, and a second channel in fluid communication with the second outlet passage, said slide valve extends within the center bore of the main body portion defining a first partitioned area and a second partitioned area;
a cylinder attached to the slide valve;
wherein the inlet end portion having an opening, said opening having an approximate 4-12 square inch cross section;
wherein the first and second outlet end portions each having an opening, each of said openings having an approximate 0.75 square inch cross section.

9. The injection molding head as recited in claim 8, wherein the slide valve further defining a first flow channel that directs the material to the first channel, and a second flow channel that directs the material to the second channel.

10. The injection molding head as recited in claim 8, wherein the cylinder is a hydraulic cylinder.
